(19) United States
(12) Patent Application Publication
(10) Pub. No.: US 2005/0232218 A1
(43) Pub. Date: Oct. 20, 2005

(54) Low-power operation of systems requiring low-latency and high-throughput

(75) Inventors: Bruce E. Edwards, Belmont, MA (US); Mark D. Matson, Acton, MA (US); Walter A. Morton, Pleasanton, CA (US); Jay Pattin, Waban, MA (US)

Correspondence Address: GARLICK HARRISON & MARKISON LLP, P.O. BOX 160727, AUSTIN, TX, 78716-0727, US

(73) Assignee: Broadcom Corporation, Irvine, CA (US)

(21) Appl. No.: 11/044,117

(22) Filed: Jan. 27, 2005

Related U.S. Application Data
(60) Provisional application No. 60/563,362, filed on Apr. 19, 2004.

(51) Int. Cl. H04B 7/212

(52) U.S. Cl. 370/347

(57) ABSTRACT

A method and apparatus for providing multiple clock signals for a communication device, with the clock signals being generated to correspond to the operating mode of various core modules of the communication device. A clock generator is operable to generate a plurality of clock signals having performance characteristics corresponding to the operating mode of individual cores in the system. A clock management logic circuit is operable to receive a plurality of request signals from the core modules and to cause the clock generator to generate appropriate clock signals based on the requests and other information relating to the operating mode of the core modules.

### RELATED APPLICATIONS

This application claims priority to the U.S. Provisional Application No. 60/563,362, which was filed on Apr. 19, 2004, and is incorporated herein by reference in its entirety.

### BACKGROUND OF THE INVENTION

1. Field of the Invention

The present invention relates in general to the field of data processing. In one aspect, the present invention relates to a method and system for managing clock functions in a communications processor to provide low power operation of systems requiring both low-latency and high-throughput.

2. Related Art

Data processors are used in a variety of applications, including communication systems formed with wireless and/or wire-lined communication devices. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards including, but not limited to, IEEE 802.11, Bluetooth, advanced mobile phone services (AMPS), digital amps, global system for mobile communications (GSM), code division multiple access (CDMA), local multi-point distribution systems (LMDS), multi-channel-multi-point distribution systems (MMDS) and/or variations thereof.

Especially with wireless and/or mobile communication devices (such as a cellular telephone, two-way radio, personal digital assistant (PDA), personal computer (PC), laptop computer, home entertainment equipment, etc.), the processor or processors in a device must be able to run various complex communication programs using only a limited amount of power that is provided by power supplies, such as batteries, contained within such devices. In particular, for a wireless communication device to participate in wireless communications, the device includes a built-in radio transceiver (i.e., receiver and transmitter) or is coupled to an associated radio transceiver (e.g., a station for in-home and/or in-building wireless communication networks, RF modem, etc.).

To implement the transceiver function, one or more processors and other modules are used to form a transmitter which typically includes a data modulation stage, one or more intermediate frequency stages, and a power amplifier. The data modulation stage converts raw data into baseband signals in accordance with a particular wireless communication standard. The intermediate frequency stages mix the baseband signals with one or more local oscillations to produce RF signals. The power amplifier amplifies the RF signals prior to transmission via an antenna. In addition, one or more processors and other modules are used to form a receiver which is typically coupled to an antenna and includes a low noise amplifier, one or more intermediate frequency stages, a filtering stage, and a data recovery stage. The low noise amplifier receives inbound RF signals via the antenna and amplifies them. The intermediate frequency stages mix the amplified RF signals with one or more local oscillations to convert the amplified RF signal into baseband signals or intermediate frequency (IF) signals. The filtering stage filters the baseband signals or the IF signals to attenuate unwanted out-of-band signals to produce filtered signals. The data recovery stage recovers raw data from the filtered signals in accordance with the particular wireless communication standard.

In addition to the complexity of the computational requirements for a communications transceiver, such as described above, the ever-increasing need for higher speed communications systems imposes additional performance requirements and resulting costs for communications systems. In order to reduce costs, communications systems are increasingly implemented using Very Large Scale Integration (VLSI) techniques. The level of integration of communications systems is constantly increasing to take advantage of advances in integrated circuit manufacturing technology and the resulting cost reductions. This means that communications systems of higher and higher complexity are being implemented in a smaller and smaller number of integrated circuits. For reasons of cost and density of integration, the preferred technology is CMOS. To this end, digital signal processing (“DSP”) techniques generally allow higher levels of complexity and easier scaling to finer geometry technologies than analog techniques, as well as superior testability and manufacturability.

Because of the computational intensity (and the associated power consumption by the processor(s)) for such transceiver functions, it is an important goal in the design of wireless and/or mobile communication devices to minimize processor and other module operations (and the associated power consumption). One way to manage power consumption in a system is to coordinate the operation of the various clocks to optimize power consumption.

The various components in a wireless device have different operating requirements for the clock signals used for their operation. Network devices generally require high-speed, high-accuracy clocks. However, these clocks consume large amounts of power due to the power required to create a high-accuracy clock and the power consumed while switching the clock drivers and clock network at high frequencies. Therefore, network devices typically have power saving modes which allow stations to enter a low-power mode when the stations are not accessing the medium. Specifically, if the device is not transmitting or receiving, it is possible to conserve power by generating a lower frequency and lower accuracy clock signal which suffices to meet certain system requirements.

It would be desirable, therefore, to provide a communication device having a power management system capable of conserving power by controlling the clock generator to provide different clock signals that are matched to the specific operational requirements of the system at any time. Prior techniques are generally oriented towards total system power control. In these mechanisms, the clock is usually totally disabled in the peripheral when the main processor enters a low power-state. There are also fine-grained mechanisms which turn off the clocks locally to individual circuits. While from a theoretical standpoint these fine-grained control schemes would save the most power, they fail to save the power dissipated by distributing the high-frequency clock. This is a very substantial portion of the power. Other schemes that disable the clock require some kind of complicated logic or software to ensure that the clock is on when the device is being used.

In view of the foregoing, it is apparent that it would be desirable to provide a wireless device having a power management system capable of conserving power by controlling the clock generator to provide different clock signals that are matched to the specific operational requirements of the system at any time, while also providing a means to maintain proper operation of the device when operating in a low-power mode.

### SUMMARY OF THE INVENTION

The present invention overcomes shortcomings of the prior art by providing a method and apparatus for providing multiple clock signals for a communication device, with the clock signals being generated to correspond to the operating mode of various core modules of the communication device. The present invention comprises a plurality of core modules for processing data to implement functions. In one embodiment, at least one of the core modules is operable to transmit data to, and receive data from, at least one wirelessly enabled external device. A clock generator is operable to generate a plurality of clock signals having performance characteristics corresponding to the operating mode of individual cores in said plurality of core modules. A clock management logic circuit is operable to receive a plurality of request signals from the core modules and to cause the clock generator to generate one of the plurality of clock signals based on the requests and other information relating to the operating mode of the core modules. One embodiment of the clock management circuitry is operable to provide a mode wherein the clock corresponding to any of the aforementioned modes stays on for a predetermined length of time, thereby decreasing the latency in case there is a new reference.

The present invention offers numerous advantages over the prior art. Individual cores are free to define the system clock required for their references. In the present invention, the clock management circuitry chooses the slowest clock that meets all of the cores' requirements. The definition of the cores' requirements can be changed on a system basis so that a high throughput (HT) clock in one system can be translated into an active low-power (ALP) mode clock in another. This allows the best system-wide power savings without requiring changes to the cores. In addition, the present invention does not require any software intervention.

The objects, advantages and other novel features of the present invention will be apparent from the following detailed description when read in conjunction with the appended claims and attached drawings.

### BRIEF DESCRIPTION OF THE DRAWINGS

FIG. 1 is a schematic block diagram of a communication system in accordance with an exemplary embodiment of the present invention.

FIG. 2 is a schematic block diagram of an exemplary embodiment of the present invention for a method and apparatus for low-power operation of systems requiring both low-latency and high-throughput.

### DETAILED DESCRIPTION

A method and apparatus for an improved communications processor is described. While various details are set forth in the following description, it will be appreciated that the present invention may be practiced without these specific details. For example, selected aspects are shown in block diagram form, rather than in detail, in order to avoid obscuring the present invention. Some portions of the detailed descriptions provided herein are presented in terms of algorithms or operations on data within a computer memory. Such descriptions and representations are used by those skilled in the data processing arts to describe and convey the substance of their work to others skilled in the art. In general, an algorithm refers to a self-consistent sequence of steps leading to a desired result, where a “step” refers to a manipulation of physical quantities which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities. Unless specifically stated otherwise as apparent from the following discussion, it is appreciated that throughout the description, discussions using terms such as processing, computing, calculating, determining, displaying or the like, refer to the action and processes of a computer system, or similar electronic computing device, that manipulates and/or transforms data represented as physical, electronic and/or magnetic quantities within the computer system's registers and memories into other data similarly represented as physical quantities within the computer system memories or registers or other such information storage, transmission or display devices.

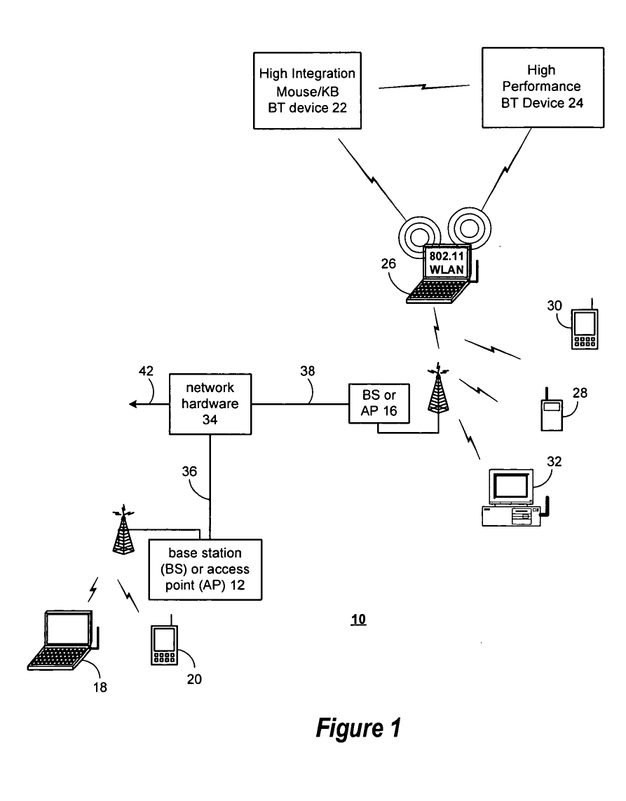

FIG. 1 illustrates a communication system 10 in which embodiments of the present invention may operate. As illustrated, the communication system 10 includes a plurality of base stations and/or access points 12, 16, a plurality of wireless communication devices, and a network hardware component 34. The wireless communication devices may be laptop host computers 18, 26, personal digital assistant hosts 20, 30, personal computer hosts 32, cellular telephone hosts 28 and/or wireless keyboards, mouse devices or other Bluetooth devices 22, 24.

As illustrated, the base stations or access points 12, 16 are operably coupled to the network hardware 34 via local area network connections 36, 38. The network hardware 34 (which may be a router, switch, bridge, modem, system controller, etc.) provides a wide area network connection 42 for the communication system 10. Each of the base stations or access points 12, 16 has an associated antenna or antenna array to communicate with the wireless communication devices in its area. Typically, the wireless communication devices register with a particular base station or access point 12, 16 to receive services from the communication system 10. For direct connections (e.g., point-to-point communications between laptop 26 and mouse or keyboard 22), wireless communication devices communicate directly via an allocated channel.

Regardless of the particular type of communication system, each wireless communication device includes a built-in radio and/or is coupled to a radio. The radio includes a highly linear amplifier and/or programmable multi-stage amplifier with a low latency power saving mechanism as disclosed herein to enhance performance, reduce costs, reduce size, reduce power consumption and/or enhance broadband applications.

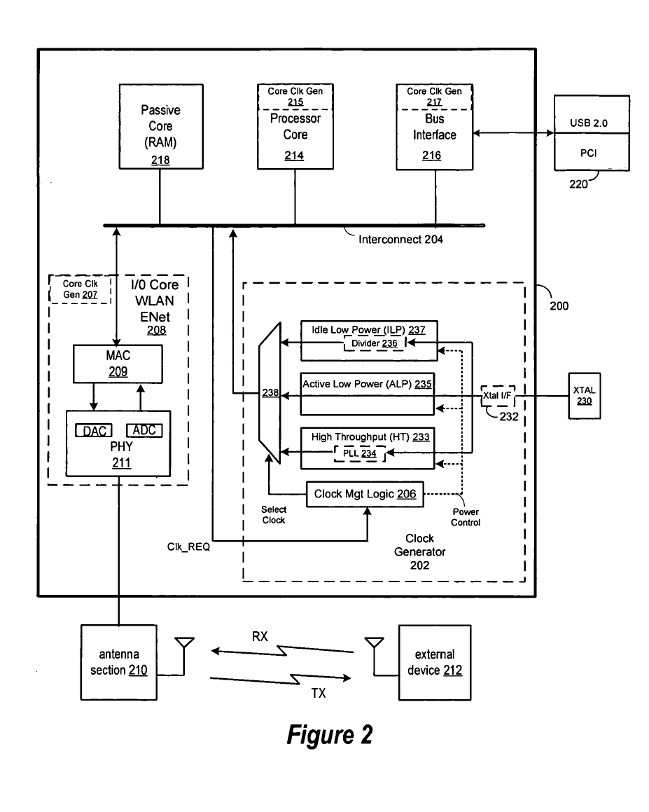

FIG. 2 is a schematic block diagram of an exemplary embodiment of the present invention for a method and apparatus for low-power operation of systems requiring both low-latency and high-throughput. In the embodiment illustrated in FIG. 2, the present invention is implemented in a communications system 200 in a system-on-a-chip (SOC) configuration that can be incorporated into the various communication devices illustrated in FIG. 1. The communications system comprises a plurality of core modules including a communication I/O core 208, a processor core 214, a bus interface core 216, and a passive memory core (RAM) 218. The bus interface core 216 is operable to communicate with an external bus interface 220, that may include a USB 2.0 or PCI interface. The communication I/O core 208 is operable to perform WLAN and other networking functions and further is operable to transmit and receive data signals via antenna section 210 for communication with an external device 212. The communication I/O core 208, processor core 214, and bus interface core 216 each contain internal core clock generators, i.e., core clock generators 207, 215, and 217, respectively.

The communication system 200 comprises a clock generator 202 that is operable to generate a plurality of clock signals to an interconnect bus 204. The clock generator comprises a high-throughput (HT) generator module 233, an active low-power (ALP) module 235, and an idle low-power (ILP) module 237. A clock management logic circuit 206 is operable to receive a plurality of request signals from the various core modules and to generate first, second and third clock signals based on the requests and other information relating to the operating mode of the various core modules in the communication system 200. In an embodiment of the invention, the first clock corresponds to an idle low-power mode (ILP), the second clock corresponds to an active low-power mode (ALP), and the third clock corresponds to a high-throughput (HT) power mode. Therefore, the requests can be ALP_REQ to request an active low-power clock signal or HT_REQ for a high-throughput clock signal. If there is no request for either of the aforementioned clock signals, the clock generator will generate an idle low-power (ILP) clock signal. The HT clock is generated by a phase locked loop 234 that receives a signal from crystal 230 via the crystal interface 232. The output of the crystal interface 232 is provided directly to the ALP clock module and the ALP clock output is based directly on the crystal frequency. The signal from the crystal interface 232 is also provided to the divider 236 in the idle low-power clock module. The outputs of each of the respective clock modules are provided to the multiplexer 238, which provides one of the three clock signals as an output in response to a power control signal generated by the clock management logic 206.

In the communication system 200, the clock generation is required to support low-latency interface register access while requiring the lowest possible idle power. In the present invention, control of the clocks for the cores is implemented in hardware in order to reduce the complexity of software drivers. The software drivers do not need to perform any additional clock control operations to perform register access or to initiate DMA transfers. The clock generator 202 will automatically switch between three different global clocking modes, based on the activity of the cores and interfaces. The global mode controls the frequency of the interconnect bus clock and interface circuits responsive to the interconnect bus 204. As discussed above, the three global clock modes are: Idle low-power (ILP), Active low-power (ALP), and High-throughput (HT). ILP mode is used when there is no interconnect bus activity required, or long-latency accesses are permitted. To minimize power consumption the various cores should also be in their lowest power state, consistent with internally active (non-reset) operation. In ILP mode, the interconnect bus clock frequency is programmable, and in one embodiment operates in a frequency range of 3 KHz-1 MHz. ALP mode is used when the interconnect bus is being actively utilized, and relatively low latency interface access is required. ALP mode is used for register access, and low-rate DMA. The clock frequency of the interconnect bus 204 is the same as the crystal frequency in ALP mode. HT mode is used when the full bandwidth of the interconnect bus is required, or to achieve extreme low-latency access. The interconnect bus clock frequency is chip dependent in HT mode, but typically it will be supplied from some high-frequency PLL and will be 80-88 MHz.

Each core may request either ALP or HT mode operation, with ILP mode being the default if no requests are made. The clock generator 202 operates in the highest operating mode requested by any core and is operable to switch between ILP and ALP modes within a few cycles of the crystal clock. The latency of the switch to HT mode is system dependent. It may take only a few cycles of the PLL generated clock if the PLL is active, or it make take 50-100 us if the PLL is inactive and is powered up in response to the HT requests.

In one embodiment of the invention, individual clock cores have a free-running 16-20 MHz crystal clock which can operate in a low-power mode. The individual core clocks are used for the respective cores' internal data paths. The communication I/O core 208 comprises a MAC/PHYclock 207, and/or an Ethernet clock.

The communication system comprises separate clock domains. For example, the interconnect bus clock is for the interconnect bus 204 and some cores which do not have individual core clocks. In addition, there are separate interface clocks that are supplied or controlled by an external interface. Examples of such clocks include a PCI, USB or processor clock.

One embodiment of the clock management logic 206 is operable to provide a mode wherein the clock corresponding to any of the aforementioned modes stays on for a predetermined length of time, thereby decreasing the latency in case there is a new reference. For a system comprising “n” cores, this allows a burst of requests to complete in less time than would be required to complete “n” requests based on “n” single request time periods. This mechanism can be combined with a PLL power controller and use the fastest clock available (ALP) until the high-throughput clock is available. Individual clock modes can be disabled for certain system applications. For example, if the interface used in a specific system requires ALP mode, then the ILP mode can and must be disabled, and ALP operation becomes the default.

While the system and method of the present invention has been described in connection with the preferred embodiment, it is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

1. A data processing system for enabling communication, comprising:
a plurality of core modules for processing data, wherein individual core modules in said plurality of core modules are operable to generate individual requests for clock signals corresponding to the operating mode of said individual core modules;
a clock generator operable to generate a plurality of clock signals having performance characteristics corresponding to said operating mode of individual cores in said plurality of core modules; and
a clock management logic circuit operable to receive said individual requests from said individual core modules and to cause said clock generator to generate one of said plurality of clock signals based on said requests, wherein said generated clock signal corresponds to the highest operating mode of said individual core modules.

2. The data processing system of claim 1, wherein one of said plurality of clock signals comprises a low-power idle clock.

3. The data processing system of claim 2, wherein the clock management logic circuit is operable to generate said low-power idle clock in the absence of requests from said cores.

4. The data processing system of claim 1, wherein one of said plurality of clock signals comprises an active low-power clock signal.

5. The data processing system of claim 1, wherein one of said plurality of clock signals comprises a high-throughput clock signal.

6. The data processing system of claim 5, wherein said high-throughput clock is generated by a phase locked loop.

7. The data processing system of claim 1, wherein one of said plurality of cores comprises a processor core.

8. The data processing system of claim 1, wherein one of said plurality of cores comprises a bus interface.

9. The data processing system of claim 1, wherein one of said plurality of cores comprises an I/O core.

10. The data processing system of claim 1, wherein said plurality of clock signals are provided as inputs to a multiplexer, said multiplexer being controlled by said clock management logic to deliver said clock signals to an interconnect bus operably coupled to said plurality of cores.

11. A method of controlling operation of a plurality of processing core modules for enabling communication, wherein individual core modules in said plurality of core modules are operable to generate individual requests for clock signals corresponding to the operating mode of said individual core modules, comprising:
enabling a clock generator to generate a plurality of clock signals having performance characteristics corresponding to the operating mode of individual cores in said plurality of core modules; and
controlling said clock generator with a clock management logic circuit operable to receive said individual requests from said individual core modules and to cause said clock generator to generate one of said plurality of clock signals based on said requests, wherein said generated clock signal corresponds to the highest operating mode of said individual core modules.

12. The method of claim 11, wherein one of said plurality of clock signals comprises a low-power idle clock.

13. The method of claim 12, wherein the clock management logic circuit is operable to generate said low-power idle clock in the absence of requests from said cores.

14. The method of claim 11, wherein one of said plurality of clock signals comprises an active low-power clock signal.

15. The method of claim 11, wherein one of said plurality of clock signals comprises a high-throughput clock signal.

16. The method of claim 14, wherein said high-throughput clock is generated by a phase locked loop.

17. The method of claim 11, wherein one of said plurality of cores comprises a processor core.

18. The method of claim 11, wherein one of said plurality of cores comprises a bus interface.

19. The method of claim 11, wherein one of said plurality of cores comprises an I/O core.

20. The method of claim 11, wherein said plurality of clock signals are provided as inputs to a multiplexer, said multiplexer being controlled by said clock management logic to deliver said clock signals to an interconnect bus operably coupled to said plurality of cores.
